(19) United States
(12) Patent Application Publication
(10) Pub. No.: US 2012/0042461 A1
(43) Pub. Date: Feb. 23, 2012

(54) Pipe Cleaning Apparatus

(75) Inventors: Michael P. Antal, Slippery Rock, PA (US); Brian Antal, Fombell, PA (US)

(73) Assignee: ITC, INC., Ellwood City, PA (US)

(21) Appl. No.: 13/210,714

(22) Filed: Aug. 16, 2011

Related U.S. Application Data
(60) Provisional application No. 61/374,355, filed on Aug. 17, 2010.

(51) Int. Cl. B08B 9/045; B08B 1/04

(52) U.S. Cl. 15/104.05; 15/104.13

(57) ABSTRACT

A pipe cleaning apparatus for cleaning pipes or tubes includes a plurality of scrapers and a plurality of spacers secured to a shaft. Each scraper includes a scraper body with an outer perimeter defining a scraper blade adapted to contact an inner surface of a tube and at least one radial slot defined by the body. Each of the scrapers and spacers are inserted onto a cylindrical shaft. Each spacer is sandwiched between two adjacent scrapers. The scrapers are adapted to contact an inner surface of a tube or a pipe.

### CROSS REFERENCE TO RELATED APPLICATION

This application claims priority to U.S. Provisional Patent Application No. 61/374,355, filed Aug. 17, 2010, entitled “Pipe Cleaning Apparatus”, the entire disclosure of which is herein incorporated by reference.

### BACKGROUND OF THE INVENTION

1. Field of the Invention

The present invention generally relates to the field of pipe cleaning devices and, more particularly, to plug assemblies operative for cleaning an inner surface of heat exchanger and condenser tubing or piping.

2. Description of the Related Art

Heat exchanger systems typically have a plurality of tubes or pipes through which a liquid cooling or heating medium, such as water, flows to remove heat from, or add heat to, an industrial process or the like. Inner surface of heat exchanger tubing or piping is prone to accumulating sediment from the liquid medium. Accumulation of sediment from the liquid medium presents many problems, such as deposits and obstructions, which limit heat transfer efficiency and life expectancy of the tubing. Slime, sticks, mud, shells, calcium carbonate scale or manganese scale are examples of additional problems caused by sediment accumulation on the inside surface of tubing or piping.

Pipe cleaning assemblies have been developed to aid in removal of accumulated sediment. Typically, these pipe cleaning assemblies include a fin or blade arrangement attached to a body. Such pipe cleaning assembly is placed at one end of the tube to be cleaned with the fins in contact with an inner surface of the tube. High pressure water or other propelling fluid is applied to the tube to force the pipe cleaning assembly through the tube. This causes the fin or blade arrangement to move axially within the tube and, in the process, scrape the inner surface of the tube and remove obstructions and deposits along the way until the pipe cleaning assembly exits the tube. A properly cleaned inner surface of the tube yields increased heat exchanger and condenser efficiency and prolongs the life expectancy of the tubing.

Within the prior art, U.S. Pat. No. 3,939,519 to Muirhead is directed to a tube cleaning plug having an elongated core body and a plurality of spaced scraper discs provided along the body. The scraper discs have radial slits extending from a surface adjacent to the body to their outer periphery to define a plurality of segments. The segments are flexible to allow deflection during insertion into a pipe and passage therethrough. The slits allow for passage of propelling fluid and sediment dislodged by the scraper discs contacting the inner surface of the pipe.

U.S. Pat. No. 4,178,649 to Kouse et al. discloses a tube cleaning device having a plurality of scraper elements removably coupled to form a chain. Each scraper element includes a centrally-located body having a recessed portion and a protruding portion. The recessed portion is dimensioned such that it accepts the protruding portion of an adjacent scraper element. A plurality of flexible scraper elements extend radially outward from the body. A plurality of scraper elements may be coupled to form a flexible chain which may be passed through the tortuous path of a typical heat exchanger system.

U.S. Pat. No. 5,528,790 to Curran teaches a scraper assembly that is forced through heat exchanger tubes at high pressure for scraping deposits from an inner surface of tubes. A cylindrical body having a barrel, a head, and a tail end receives a plurality of rings spaced apart axially along the barrel. Spacer sleeves separate the rings in an alternating manner. Each ring includes a radial compression slot formed at an angle relative to the axial direction of the barrel to create a rifling effect as the scraper assembly is passed through the tube.

The pipe cleaning assemblies can be made from a polymeric material, as exemplified by the FLEX-DART™ pipe cleaning assembly manufactured by ITC, Inc., the assignee of this patent application. For more difficult deposits, a metal fin can be used, such as the stainless steel DART™ pipe cleaning assembly manufactured by ITC, Inc., the assignee of this patent application, and shown in FIG. 1.

Specifically, FIG. 1 shows a prior art stainless steel DART™ pipe cleaning assembly 10 that includes a unitary plastic body 12 having a plurality of stamped metal scraper blades 14 removably attached thereto. The metal scraper blades 14 include an engagement portion 16 and a scraping blade portion 18. Legs 20 connect the scraping blade portion 18 to the engagement portion 16. Windows 22 are defined by the legs 20. The scraping blade leg portion 18 is defined by three arcuate segments 24 of approximately 90° and results in a non-continuous member with a body receiving opening 26. Finally, a tip 28 and a tail piece 30 are provided on the body 12. Preferably, three metal scraper blades 14 are received by the body 12. The metal scraper blades 14 are axially spaced apart from each other and circumferentially offset so that the pipe cleaning assembly 10 contacts the complete periphery of the inner surface of the pipe as it is pushed through the tube. Although the pipe cleaning assembly 10 works well, it must be preassembled which requires a substantial amount of labor costs.

Numerous other disadvantages are associated with the prior art designs. Prior art embodiments that utilize metal scraper blades are expensive to manufacture because of their non-circular shape, often resulting in a high manufacturing rejection rate. Furthermore, existing designs cannot be easily repaired in the field, which can further extend the downtime of a heat exchanger or condenser system. Additionally, scraper blades made from plastic or polymeric materials are often highly flexible, which causes them to deflect over sediments rather than dislodge them from the inside surface of the tube.

In view of the foregoing, a need exists for a pipe cleaning apparatus that can be easily assembled and repaired in the field within minimum skill and labor requirements. An additional need exists for providing a pipe cleaning apparatus that effectively removes sediments from the inner surface of heat exchanger and condenser tubes. Furthermore, there exists a need for a pipe cleaning apparatus having low manufacturing costs.

### SUMMARY OF THE INVENTION

According to one embodiment, a pipe cleaning apparatus for cleaning an inner surface of tubing or piping includes a cylindrically-shaped shaft having a head provided at a first end, and a cap provided at a second end, and a plurality of scrapers provided on the shaft. Each scraper may be longitudinally spaced apart and coaxially aligned along the axial length of the shaft. The pipe cleaning apparatus may additionally include a plurality of spacers provided on the shaft in a coaxial arrangement for longitudinally spacing apart the scrapers. Each scraper desirably has a central opening extending through the scraper along its longitudinal axis and a radial slot extending from the central opening to the outer perimeter of the scraper.

According to another embodiment, the pipe cleaning apparatus may be adapted for insertion into a pipe. In accordance with this embodiment, each scraper desirably has an outer diameter slightly larger than an inner diameter of the pipe. In this manner, each scraper is adapted to deflect slightly toward a central axis of the scraper, such that the outer perimeter of the scraper is always in contact with the inner surface of the pipe.

In accordance with another embodiment of the pipe cleaning apparatus, diameter of the central opening of each scraper is preferably slightly larger than the diameter of the shaft to allow the scraper to slide along the shaft. Each spacer may have a central hole extending along a central axis of the spacer. Similar to the scraper structure, diameter of the central hole may be slightly larger than the diameter of the shaft to allow the spacer to slide along the shaft. Each scraper and spacer may be independently rotatable about the longitudinal axis of the shaft. Additionally, each spacer is desirably uniform in length to maintain the scrapers substantially equidistant to each other.

According to another embodiment of the pipe cleaning apparatus, the length of each scraper in the axial direction may be substantially smaller than the width in the radial direction. Desirably, the pipe cleaning apparatus may have a modular construction, such that one or more scrapers or spacers may be added or subtracted to increase or decrease the length of the pipe cleaning apparatus.

In one embodiment of the pipe cleaning apparatus, the shaft may be a rivet such that the cap is pressed onto the second end of the shaft. Desirably, the rivet may be made of aluminum. Each scraper may be made from a non-metallic material, such as high density polyethylene. Similarly, each spacer may be made from a non-metallic material, such as propylene.

Further details and advantages of the present pipe cleaning apparatus will become apparent from the following detailed description read in conjunction with the drawings.

### BRIEF DESCRIPTION OF THE DRAWINGS

FIG. 1 is a perspective view of a pipe cleaning assembly according to a prior art embodiment;

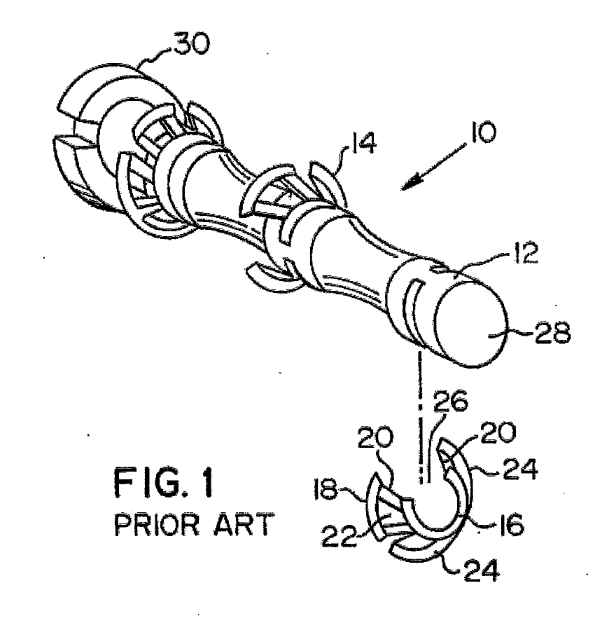

FIG. 2 is a perspective view of a pipe cleaning assembly according to one embodiment;

FIG. 3 is an exploded view of the components of the pipe cleaning assembly shown in FIG. 2;

FIG. 4 is a section view of the pipe cleaning assembly shown in FIG. 2 received in a pipe;

FIG. 5 is a side view of the pipe cleaning assembly shown in FIG. 2;

FIG. 6 is a top view of the pipe cleaning assembly shown in FIGS. 2; and

FIG. 7 is a bottom view of the pipe cleaning assembly shown in FIG. 2.

### DETAILED DESCRIPTION OF THE INVENTION

For purposes of the description hereinafter, spatial orientation terms, if used, shall relate to the referenced embodiment as it is oriented in the accompanying drawing figures or otherwise described in the following detailed description. However, it is to be understood that the embodiments described hereinafter may assume many alternative variations and embodiments. It is also to be understood that the specific devices illustrated in the accompanying drawing figures, and described herein, are simply exemplary and should not be considered as limiting. Additionally, terms “pipe”, “piping”, “hose”, “tube”, or “tubing” may be used interchangeably in reference to an annular conduit typically utilized in heat exchanger and condenser systems.

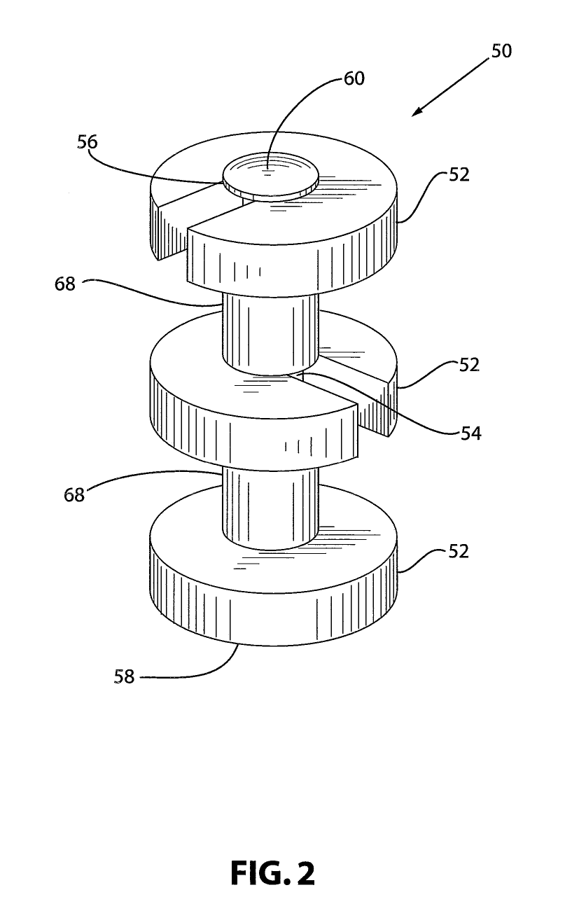

Referring to the drawings in which like reference characters refer to like parts throughout the several views thereof, the present invention is generally described in terms of a pipe cleaning apparatus for use in cleaning heat exchanger and condenser systems. With reference to FIG. 2, a pipe cleaning apparatus 50 is illustrated in accordance with one embodiment. While pipe cleaning apparatus 50 can be alternatively referred to as a pipe cleaning assembly, a pipe cleaning dart, or a pig, one of ordinary skill in the art will understand that each of these designations refers to pipe clearung apparatus 50 described herein.

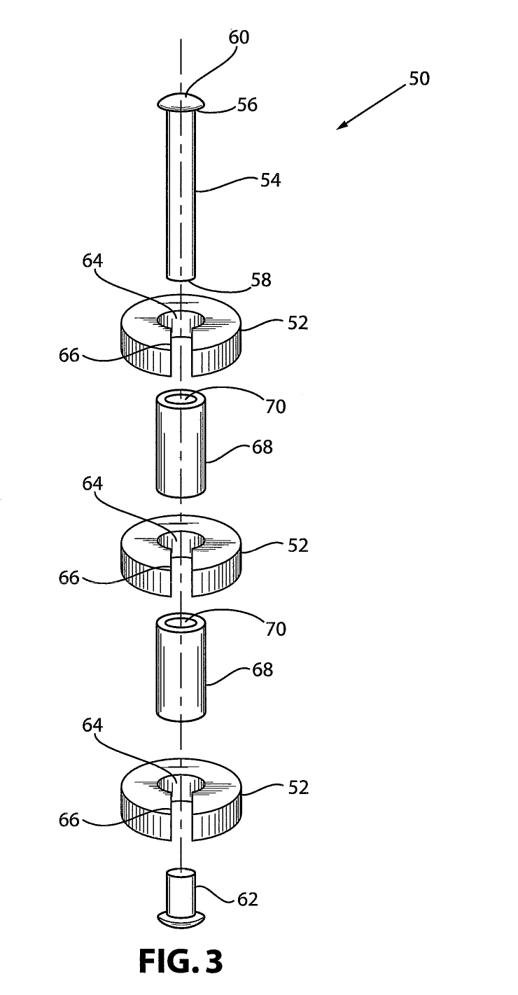

With reference to FIG. 3, and with continuing reference to FIG. 2, pipe cleaning apparatus 50 generally includes a plurality of scrapers 52 connected to a single cylindrical shaft 54. Scrapers 52 are arranged in an axially-offset manner along the length of shaft 54. Scrapers 52 are independently rotatable about the longitudinal axis of shaft 54. While FIGS. 2 and 3 illustrate an embodiment of pipe cleaning apparatus 50 having three scrapers 52, one of ordinary skill in the art will understand that more or fewer scrapers 52 may be used in different embodiments of pipe cleaning apparatus 50. In some embodiments, pipe cleaning apparatus 50 may have a modular construction where one or more scrapers 52 may be added to shaft 54 to increase or decrease, respectively, the length of pipe cleaning apparatus 50.

With continuing reference to FIG. 3, shaft 54 has a first end 56 opposite a second end 58. A cylindrically-shaped head 60 is connected to shaft 54 at first end 56. A cylindrically-shaped cap 62 is connected to shaft 54 at second end 58. Desirably, shaft 54 is an aluminum rivet where cap 62 is pressed onto second end 58 of shaft 54. In alternate embodiments, shaft 54 may be another type of a fastener, such as a bolt having a head and a threaded end. Additionally, shaft 54 may be manufactured from materials other than aluminum.

As illustrated in FIG. 3, scrapers 52 have a generally cylindrical shape. The length of scrapers 52 in the axial direction is substantially smaller than the width in the radial direction. Each scraper 52 has a central opening 64 provided through the length of scraper 52 along the central axis. The diameter of each opening 64 is slightly larger than the diameter of cylindrical shaft 54, allowing scrappers 52 to snugly slide on shaft 54. Each scraper 52 includes a radial slot 66 that allows for slight compression and expansion of scraper 52. Additionally, slot 66 enables the propelling fluid to pass between adjacent scrapers 52 of pipe cleaning apparatus 50 to flush out any loose sediment or debris dislodged from the inner surface of the tubing. Slot 66 extends from opening 64 to the outer peripheral surface of scraper 52. Desirably, slot 66 is made slightly narrower than the diameter of opening 64 to prevent scraper 52 from separating from shaft 54.

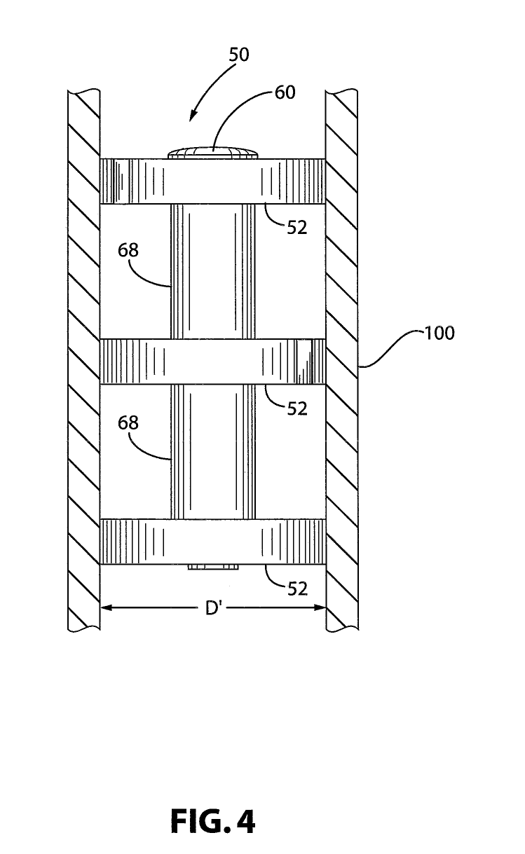

As shown in FIG. 4, pipe cleaning assembly 50 is adapted to be received within a tube or pipe 100. Desirably, scrapers 52 of pipe cleaning apparatus 50 have an outer diameter D which is slightly greater than the inner diameter D′ of pipe 100. For example, the difference between diameter D of scrapers 52 and diameter D′ of pipe 100 is on the order of several thousands of an inch, e.g., 0.005 inches. In this manner, when pipe cleaning apparatus 50 is inserted into pipe 100, scrapers 52 deflect slightly toward the central axis. This arrangement ensures that the outer perimeter of scrapers 52 is always in contact with the inner surface of pipe 100.

Referring back to FIGS. 2 and 3, scrapers 52 are desirably made of high density polyethylene material. In certain embodiments, it is desirable that scrapers 52 are made of non-metallic material to protect the inner surface of tubing. Scrapers 52 may have a cylindrical or slightly conical shape and may be made using a variety of different manufacturing techniques.

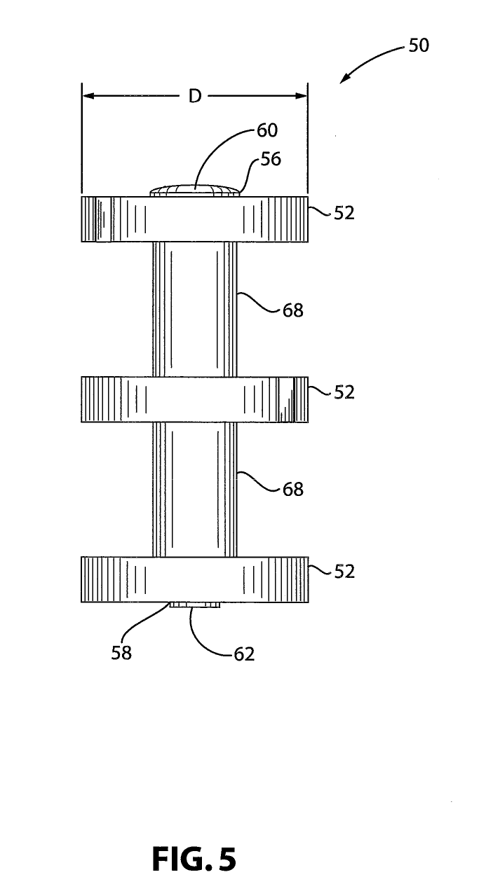

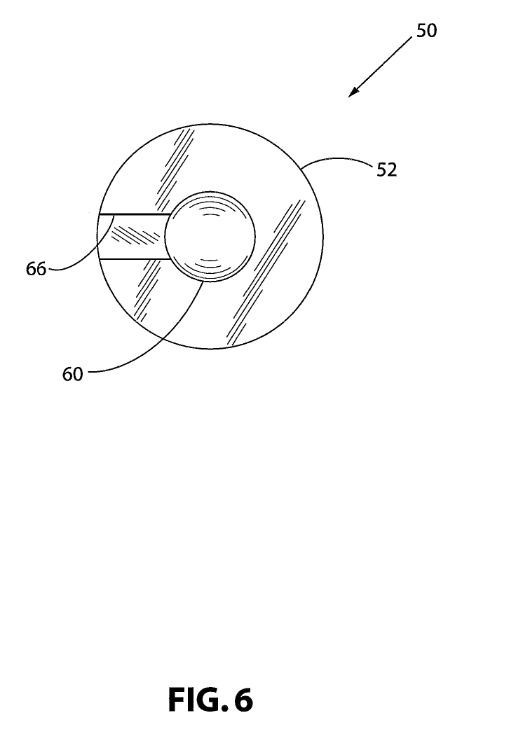

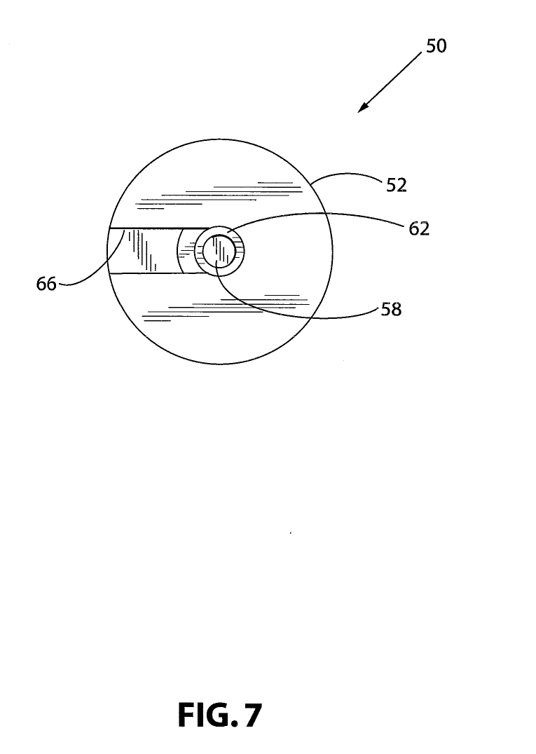

With continuing reference to FIGS. 2 and 3, a plurality of spacers 68 are inserted onto shaft 54 and between each scraper 52. Each spacer 68 has a generally cylindrical shape having a central hole 70 extending along the central axis of spacer 68. Spacers 68 are preferably equal in length, such that each scraper 52 is maintained substantially equidistant to an adjacent scraper 52. Alternatively, spacers 68 may have different lengths to maintain scrapers 52 at different distances from each other. Spacers are preferably made of propylene material. FIGS. 5-7 show top, side, and bottom views, respectively, of pipe cleaning apparatus 50 shown in FIG. 2.

Having described the structure of pipe cleaning apparatus 50 in accordance with one embodiment, assembly of pipe cleaning apparatus 50 will now be discussed with continuing reference to FIGS. 2 and 3. Initially, a scraper 52 is secured onto shaft 54 by inserting opening 64 onto second end 58 of shaft 54. Scraper 52 is slid along shaft 54 until it abuts head 60 of shaft 54. A spacer 68 is then secured onto shaft 54 by inserting hole 70 onto second end 58 of shaft 54. A second scraper 52 is then inserted in a similar manner to the first scraper 52. The second scraper 52 is slid along shaft 54 until it abuts against spacer 68. A second spacer 68 is inserted onto shaft 54 followed by a third scraper 52. A cap 62 is then permanently fastened onto a second end 58 of shaft 54 to hold pipe cleaning apparatus 50 together. In embodiments where a greater number of scrapers 52 is required, this installation procedure can be repeated until a requisite number of scrapers 52 are attached to shaft 54.

In operation, the assembled pipe cleaning apparatus 50 is inserted in pipe 100 by inserting either the first end 56 or second end 58 of shaft 54. High pressure propelling fluid, such as water, is supplied to pipe 100. The pressure provided by the propelling fluid forces pipe cleaning apparatus 50 to move through pipe 100 toward an exit end with a portion of cleaning fluid passing through the slots 66 of scrapers 52. Scrapers 52 dislodge accumulated deposits from the inner surface of pipe 100. The dislodged deposits are then pushed along by scrapers 52 or are carried by the propelling fluid passing through slots 66. After pipe cleaning apparatus 50 exits pipe 100, the process can be repeated on another pipe 100.

The pipe cleaning apparatus 50 is desirably assembled prior to use. However, it may also be assembled onsite, as needed. Further, the present pipe cleaning apparatus 50 permits repair of the cleaning plug assemblies onsite by replacing any damaged scrapers 52 and/or shafts 54. Also, a number of scrapers 52 of the pipe cleaning apparatus 50 can be modified onsite. Specifically, if it is determined that three scrapers 52 do not adequately clean the pipe 100, then additional scrapers 52 can be added to the pipe cleaning apparatus 50.

Further, the present pipe cleaning apparatus 50 has a simplified construction that is easier to assemble than the previously described prior art because the orientation of scrapers 52, relative to shaft 54, is not important as is the case in the prior art. Additionally, scrapers 52 of the present pipe cleaning apparatus may be manufactured with higher tolerances because of their simple construction relative to embodiments described in the prior art. This minimizes the rejection rate of scrapers 52 and simplifies their manufacture compared to the prior art.

While an embodiment of pipe cleaning apparatus is shown in the accompanying figures and described herein in detail, other embodiments will be apparent to, and readily made by those skilled in the art, without departing from the scope and spirit of the invention. For example, while the present disclosure generally discusses the pipe cleaning assembly for use in cleaning heat exchanger and condenser piping and tubing, it is contemplated that various embodiments of the present pipe cleaning assembly may be applicable to cleaning the inner surface of pipes or tubes used in various other applications. The scope of the invention will be measured by the appended claims and their equivalents.

The invention claimed is:

1. A pipe cleaning apparatus for cleaning an inner surface of tubing or piping, the pipe cleaning apparatus comprising:
a cylindrically-shaped shaft having a head provided at a first end, a cap provided at a second end, and a longitudinal axis extending between the first end and the second end;
a plurality of scrapers provided on the shaft, each scraper being longitudinally spaced apart and coaxially aligned along the axial length of the shaft; and
a plurality of spacers provided on the shaft in a coaxial arrangement between the scrapers for longitudinally spacing apart the scrapers along the axial length of the shaft,
wherein each scraper has a central opening extending through the scraper along its longitudinal axis and a radial slot extending from the central opening to an outer perimeter of the scraper.

2. The pipe cleaning apparatus of claim 1, wherein each scraper is adapted for insertion into a pipe and wherein each scraper has an outer diameter slightly larger than an inner diameter of the pipe.

3. The pipe cleaning apparatus of claim 2, wherein each scraper is adapted to deflect slightly toward a central axis of the scraper.

4. The pipe cleaning apparatus of claim 1, wherein the diameter of the central opening of each scraper is slightly larger than the diameter of the shaft to allow the scraper to slide along the shaft.

5. The pipe cleaning apparatus of claim 1, wherein each spacer has a central hole extending along a central axis of the spacer, the diameter of the central hole being slightly larger than the diameter of the shaft to allow the spacer to slide along the shaft.

6. The pipe cleaning apparatus of claim 1, wherein each scraper is independently rotatable about the longitudinal axis of the shaft.

7. The pipe cleaning apparatus of claim 1, wherein each spacer is independently rotatable about the longitudinal axis of the shaft.

8. The pipe cleaning apparatus of claim 1, wherein each spacer is uniform in length to maintain the scrapers substantially equidistant to each other.

9. The pipe cleaning apparatus of claim 1, wherein the length of the scrapers in the axial direction is substantially smaller than the width in the radial direction.

10. The pipe cleaning apparatus of claim 1, wherein the pipe cleaning apparatus has a modular construction such that one or more scrapers or spacers made be added or subtracted to increase or decrease the length of the pipe cleaning apparatus.

11. The pipe cleaning apparatus of claim 1, wherein the cap is pressed onto the second end of the shaft.

12. The pipe cleaning apparatus of claim 1, wherein the cap is formed as a rivet.

13. The pipe cleaning apparatus of claim 12, wherein the rivet is made of aluminum.

14. The pipe cleaning apparatus of claim 1, wherein each scraper is made from a non-metallic material.

15. The pipe cleaning apparatus of claim 14, wherein each scraper is made from a high density polyethylene material.

16. The pipe cleaning apparatus of claim 1, wherein each spacer is made from a propylene material.

17. A pipe cleaning system comprising:
a) a pipe; and
b) a pipe cleaning apparatus adapted for being inserted into the pipe for cleaning an inner surface of the pipe, wherein the pipe cleaning apparatus comprises:
a cylindrically-shaped shaft having a head provided at a first end, a cap provided at a second end, and a longitudinal axis extending between the first end and the second end;
a plurality of scrapers provided on the shaft, each scraper being longitudinally spaced apart and coaxially aligned along the axial length of the shaft; and
a plurality of spacers provided on the shaft in a coaxial arrangement between the scrapers for longitudinally spacing apart the scrapers along the axial length of the shaft,
wherein each scraper has a central opening extending through the scraper along its longitudinal axis and a radial slot extending from the central opening to an outer perimeter of the scraper.

18. The pipe cleaning system of claim 17, wherein each scraper has an outer diameter slightly larger than an inner diameter of the pipe.

19. The pipe cleaning system of claim 18, wherein each scraper is adapted to deflect slightly toward a central axis of the scraper.

20. The pipe cleaning apparatus of claim 17, wherein the cap is pressed onto the second end of the shaft.
